(19) United States
(12) Patent Application Publication
(10) Pub. No.: US 2025/0279689 A1
(43) Pub. Date: Sep. 4, 2025

(54) TERMINAL MODULE FOR ROTARY ELECTRIC MACHINE

(71) Applicant: SUMITOMO WIRING SYSTEMS, LTD., Mie (JP)

(72) Inventor: Koji SAKAKURA, Mie (JP)

(21) Appl. No.: 18/859,174

(22) PCT Filed: Apr. 17, 2023
(86) PCT No.: PCT/JP2023/015329

§ 371 Date: Oct. 23, 2024

(30) Foreign Application Priority Data
Apr. 27, 2022 (JP) 2022-073585

(51) Int. Cl. H02K 5/22

(52) U.S. Cl. CPC H02K 5/225

(57) ABSTRACT

A terminal module (100) electrically connects a stator constituting a rotary electric machine to a terminal block (80). The terminal module (100) includes a plurality of busbars (10, 20, 30, 40) and a holding member (50) covering the plurality of busbars (10, 20, 30, 40). The plurality of busbars (10, 20, 30) respectively have elongated extension portions (13, 23, 33) located between first end portions (11, 21, 31) and second end portions (12, 22, 32) and extending in a first direction (X), and intermediate portions located between the extension portions (13, 23, 33) and the second end portions (12, 22, 32). The extension portions (13, 23, 33) are configured to be capable of reducing vibration transmitted toward the terminal block (80) from the stator.

### TECHNICAL FIELD

The present disclosure relates to a terminal module for rotary electric machine.

### BACKGROUND

Patent Document 1 discloses a busbar that electrically connects an electric motor to a power supply circuit that supplies power to the electric motor. This busbar has a terminal portion on one end side attached to a terminal block of the power supply circuit, a terminal portion on the other end side attached to a stator terminal of the electric motor, and a main body portion that is joined to both terminal portions and electrically connects the terminal portions.

The main body portion is constituted by a conductor having flexibility.

According to such a busbar, vibration transmitted from the electric motor is absorbed by the flexible main body portion.

### PRIOR ART DOCUMENT

### Patent Document

Patent Document 1: JP 2021-009781 A

### SUMMARY OF THE INVENTION

### Problems to be Solved

Incidentally, in a terminal module for rotary electric machine equipped with such a busbar, the main body portion and terminal portions of the busbar are provided separately, and thus the number of components increases, and time and effort is needed to join the main body portion and the terminal portions.

An object of the present disclosure is to provide a terminal module for rotary electric machine that is able to reduce vibration transmitted from a rotary electric machine with a simple configuration.

### Means to Solve the Problem

A terminal module for rotary electric machine of the present disclosure is a terminal module for rotary electric machine that electrically connects a stator constituting a rotary electric machine to a terminal block, including a plurality of busbars each integrally formed of a metal plate material, and a holding member formed of an electrically insulating resin, covering the plurality of busbars, and interposed between the plurality of busbars, whereby, when an axial direction and a circumferential direction of the rotary electric machine are respectively defined as a first direction and a second direction, the plurality of busbars include a first busbar, a second busbar, and a third busbar disposed in alignment with each other in the second direction and each having a first end portion to be electrically connected to the terminal block, a second end portion to be electrically connected to a coil of the stator, an elongated extension portion located between the first end portion and the second end portion and extending in the first direction, and an intermediate portion located between the extension portion and the second end portion and covered by the holding member, and the extension portion is configured to be capable of reducing vibration transmitted toward the terminal block from the stator.

### Effect of the Invention

According to the present disclosure, vibration transmitted from a rotary electric machine can be reduced with a simple configuration.

### BRIEF DESCRIPTION OF THE DRAWINGS

FIG. 1 is a perspective view of one embodiment of a terminal module for rotary electric machine showing the terminal module attached to a terminal block.

FIG. 2 is a plan view showing a state in which the terminal module of FIG. 1 is attached to a stator.

FIG. 3 is a bottom view showing the terminal module of FIG. 1.

FIG. 4 is a perspective view showing a first busbar and a second busbar.

FIG. 5 is a perspective view showing a third busbar.

FIG. 6 is a perspective view showing a fourth busbar.

FIG. 7 is a perspective view showing a primary mold body.

FIG. 8 is a bottom view showing the primary mold body of FIG. 7.

FIG. 9 is a cross-sectional view showing a molding process of the primary mold body of FIG. 7, in a state where a cavity of a first shaping mold is filled with molten resin.

FIG. 10 is a perspective view showing the primary mold body, the third busbar, and the fourth busbar separated from each other.

FIG. 11 is a plan view showing a state in which the third busbar and the fourth busbar are attached to the primary mold body.

FIG. 12 is a bottom view showing a state in which the third busbar and the fourth busbar are attached to the primary mold body.

FIG. 13 is a cross-sectional view showing a molding process of a secondary mold body, in a state where a cavity of a second shaping mold is filled with molten resin.

FIG. 14 is a cross-sectional view taken along line 14X-14X in FIG. 2.

### DETAILED DESCRIPTION TO EXECUTE THE INVENTION

### Description of Embodiments of Disclosure

Initially, modes of the present disclosure will be enumerated and described.

[1] A terminal module for rotary electric machine of the present disclosure is: a terminal module for rotary electric machine that electrically connects a stator constituting a rotary electric machine to a terminal block, including a plurality of busbars each integrally formed of a metal plate material, and a holding member formed of an electrically insulating resin, covering the plurality of busbars, and interposed between the plurality of busbars, whereby, when an axial direction and a circumferential direction of the rotary electric machine are respectively defined as a first direction and a second direction, the plurality of busbars include a first busbar, a second busbar, and a third busbar disposed in alignment with each other in the second direction and each having a first end portion to be electrically connected to the terminal block, a second end portion to be electrically connected to a coil of the stator, an elongated extension portion located between the first end portion and the second end portion and extending in the first direction, and an intermediate portion located between the extension portion and the second end portion and covered by the holding member, and the extension portion is configured to be capable of reducing vibration transmitted toward the terminal block from the stator.

According to this configuration, the holding member integrally holds the first busbar, the second busbar, and the third busbar, and is interposed between the busbars. Accordingly, the busbars are electrically insulated from each other by the holding member.

Also, according to the above configuration, the first busbar, the second busbar, and the third busbar have elongated extension portions that extend in the first direction, thus enhancing flexibility. As a result, vibration transmitted toward the terminal block from the stator becomes more likely to be absorbed by the extension portions. Accordingly, vibration transmitted from the rotary electric machine can be reduced with a simple configuration.

[2] Preferably, terminal module for rotary electric machine further includes a coupling member formed of an electrically insulating resin and integrally covering the extension portion of each of the first busbar, the second busbar, and the third busbar.

With the busbars, the extension portions are more likely to relatively shift in position, the longer the length of the extension portions in the first direction. In this regard, according to the above configuration, the extension portions of the busbars are integrally coupled together by the coupling member. Position shift of the extension portions of the busbars from the normal position can thereby be suppressed. Accordingly, work efficiency when connecting the first end portions of the busbars to the terminal block can be improved.

[3] Preferably, the coupling member has a plurality of holes that the extension portions respectively pass through in the first direction, and the coupling member and the extension portion of at least one of the first busbar, the second busbar, and the third busbar include a restricting part that restricts movement of the coupling member in the first direction relative to the extension portion by an engaging relationship.

According to this configuration, movement of the coupling member in the first direction relative to the extension portions of the busbars is restricted by the restricting part. Accordingly, positioning of the coupling member with respect to the busbar can be readily performed.

[4] Preferably, the restricting part includes a raised portion protruding toward an inner circumferential surface of the hole from the extension portion of at least one of the first busbar, the second busbar, and the third busbar, and a recessed portion formed in the inner circumferential surface.

According to this configuration, any movement by the coupling member in the first direction relative to the extension portion of each busbar is restricted by the engaging relationship between the raised portion protruding from the extension portion and the recessed portion formed in the inner circumferential surface of the hole in the coupling member. Accordingly, the restricting part can be realized with a simple configuration.

[5] Preferably, the raised portion is provided at a position closer to the first end portion than a central portion of the extension portion in the first direction.

With the extension portions, position shift from the normal position is more likely to occur closer to the first end portions. In this regard, according to the above configuration, the raised portion is provided at a position closer to the first end portion than the central portion of the extension portion in the first direction. Thus, the coupling member will be located closer to the first end portion than the central portion. Position shift of the extension portions of the busbars from the normal position can thereby be effectively suppressed. Accordingly, work efficiency when connecting the first end portions of the busbars to the terminal block can be further improved.

[6] Preferably, the intermediate portion of each of the first busbar, the second busbar, and the third busbar has an elongated main body portion extending in the second direction, and a leg portion formed to bend from the main body portion and extend in the first direction on an opposite side to the extension portion and coupled to the second end portion.

In a conventional terminal module, a leg portion that joins to a second end portion extends in a third direction, that is, in a radial direction of the rotary electric machine, and thus reducing the size of the rotary electric machine in the third direction is difficult.

In this regard, according to the above configuration, the leg portion of the intermediate portion is formed to bend from the main body portion and extend in the first direction on the opposite side to the first end portion. Thus, the length of the intermediate portion in the third direction can be reduced, compared to the conventional busbar in which the leg portion extends from the main body portion in the third direction. Accordingly, the physical size of the terminal module can be reduced in the third direction.

[7] Preferably, the holding member has a first holding part covering the first busbar and the second busbar and interposed between the first busbar and the second busbar, and a second holding part covering the first holding part and the third busbar.

When the cross-sectional area of the gap between the busbars is small in the case where the holding member integrally holds the first busbar, the second busbar, and the third busbar, molten resin will not flow readily through this gap within the cavity formed by the busbars and the shaping mold that forms the holding member. In the case where the cross-sectional area of the flow path on the opposite side to the above gap with the busbars interposed therebetween within the cavity is large compared to the cross-sectional area of the gap, a difference thereby occurs in the flow pressure of the molten resin that flows through the gap and the flow pressure of the molten resin that flows through the flow path. Thus, there is a problem in that the busbars are likely to shift in position from the normal position due to such a pressure difference.

In this regard, according to the above configuration, first, a primary mold body constituted by the first busbar, the second busbar and the first holding part is formed, by filling the cavity of the first shaping mold with the molten resin, in a state where the first busbar and the second busbar are inserted into the first shaping mold. Next, a secondary mold body constituted by the primary mold body, the third busbar, and the second holding part is formed, by filling the cavity of the second shaping mold with molten resin, in a state where the primary mold body and the third busbar are inserted into the second shaping mold.

Thus, the spacing between the first busbar and the second busbar can be increased, compared to the case where the cavity of the shaping mold is filled with molten resin in a state where the first busbar, the second busbar, and the third busbar are inserted into the shaping mold. The occurrence of a difference in flow pressure of the molten resin is thereby suppressed. Accordingly, position shift of the first busbar and the second busbar can be suppressed.

[8] Preferably, when a radial direction of the rotary electric machine is defined as a third direction, the third busbar has a bent portion between the extension portion and the intermediate portion of the third busbar, and the bent portion has a portion formed to bend from the extension portion and extend on an inner side in the third direction.

According to this configuration, the height of the extension portion in the first direction, that is, the position of the first end portion in the first direction, and the position of the extension portion in the third direction are adjusted simply by changing the length of the bent portion in the third direction. The dimensions of the extension portion of the third busbar can thereby be adjusted after forming the primary mold body. Accordingly, the third busbar is unlikely to shift in position, compared to the case where the cavity of the shaping mold is filled with molten resin in a state where the first busbar, the second busbar, and the third busbar are inserted into the shaping mold. Accordingly, position shift of the third busbar can be suppressed.

[9] Preferably, the first holding part has a groove portion into which a portion of the third busbar fits, the groove portion includes a bottom surface that the portion comes into contact with, and a pair of side surfaces that extend upward from both sides of the bottom surface in the second direction, and the pair of side surfaces sandwich the portion in the second direction.

According to this configuration, when forming the secondary mold body, movement of the third busbar in the second direction relative to the primary mold body due to the flow pressure of the molten resin is restricted by interference between the pair of side surfaces of the groove portion and a portion of the third busbar fitted into the groove. Accordingly, position shift of the third busbar can be further suppressed.

[10] Preferably, the plurality of busbars includes a fourth busbar to be electrically connected to a neutral wire of the coil, the first holding part includes a base portion having a first contact surface that one end surface of the third busbar in the first direction comes into contact with, and a second contact surface located on an opposite side to the first contact surface in the first direction and that the fourth busbar comes into contact with, and the second holding part covers the fourth busbar.

According to this configuration, a secondary mold body constituted by the primary mold body, the third busbar, the fourth busbar, and the second holding part is formed, by filling cavity of the second shaping mold with molten resin, in a state where the primary mold body, the third busbar, and the fourth busbar are inserted into the second shaping mold. At this time, the fourth busbar is in contact with the first holding part, and thus there is no gap between the fourth busbar and the first holding part. Position shift of the fourth busbar can thus be suppressed, compared to the case where the cavity is filled with molten resin in a state where there is a gap between the fourth busbar and the first holding part.

### DETAILED DESCRIPTION OF EMBODIMENTS OF DISCLOSURE

A specific example of a terminal module for rotary electric machine of the present disclosure will be described below with reference to the drawings. In the diagrams, parts of the configuration may be exaggerated or simplified for the convenience of description. Also, the dimensional ratios of various portions may differ between diagrams. Note that the present disclosure is not limited to these illustrative examples and is indicated by the claims, and all changes that come within the meaning and range of equivalency of the claims are intended to be embraced therein. Herein, “orthogonal” is not only strictly orthogonal but also includes generally orthogonal within a range that achieves the operation and effect of the present embodiment.

### (Overall Configuration of Terminal Module 100)

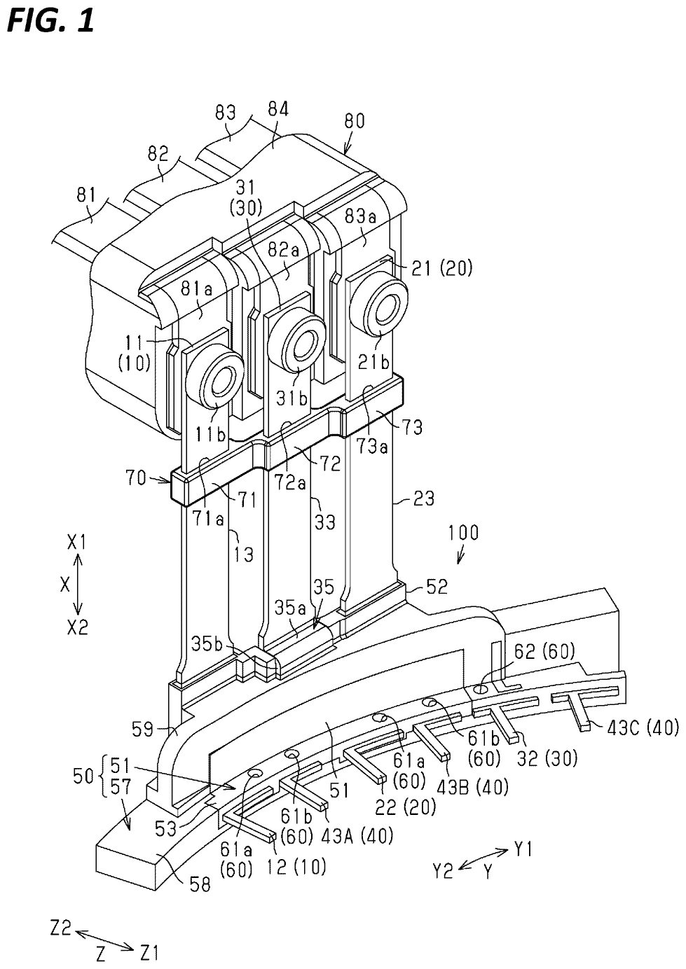

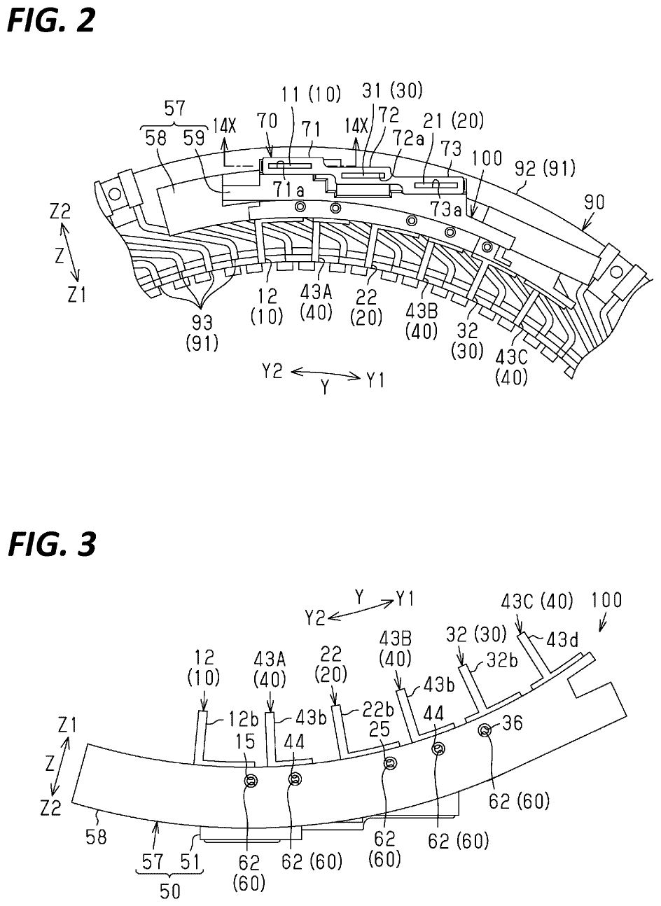

As shown in FIGS. 1 and 2, the terminal module 100 electrically connects a rotary electric machine 90 such as a motor generator (electric generator) in a hybrid vehicle or an electric vehicle, for example, and a terminal block 80.

The rotary electric machine 90 is, for example, driven by a multi-phase (in the present embodiment, 3-phase consisting of phase U, phase V, phase W) alternating current.

The rotary electric machine 90 is constituted by a tubular stator 91 provided with a stator core 92 in which a plurality of slots (not shown) are formed and a coil 93 inserted into the slots and a rotor (not shown) disposed on the inner side of the stator 91 in the radial direction. The coil 93 is constituted by three phase coils respectively corresponding to the three phases (phase U, phase V, and phase W).

The terminal block 80 has a first terminal 81, a second terminal 82, and a third terminal 83, and a housing 84 that accommodates the terminals 81, 82, and 83.

One end (81a, 82a, 83a) of each of the terminals 81, 82, and 83 in the extension direction is electrically connected to the terminal module 100. The other end of each of the terminals 81, 82, and 83 in the extension direction is electrically connected to an inverter (all not shown) that converts direct current from a battery into alternating current (in the present embodiment, 3-phase alternating current), for example. Note that, in the present embodiment, the first terminal 81 is a terminal corresponding to phase U, the second terminal 82 is a terminal corresponding to phase V, and the third terminal 83 is a terminal corresponding to phase W.

The terminal module 100 is disposed at one end portion of the stator 91 in the axial direction.

The terminal module 100 is provided with a first busbar 10, a second busbar 20, a third busbar 30, and a fourth busbar 40 that are electrically connected to the coil 93, and a holding member 50 that covers the busbars 10, 20, 30, and 40.

Also, the terminal module 100 has a coupling member 70 that integrally covers the busbars 10, 20, and 30.

Hereinafter, each constituent element of the terminal module 100 will be described in detail.

Note that, henceforth, the axial direction, circumferential direction, and radial direction of the rotary electric machine 90 will be described as a first direction X, a second direction Y, and a third direction Z, respectively. Also, in the first direction X, the side on which the terminal module 100 is disposed with respect to the stator 91 will be described as one side X1 in the first direction, and the opposite side thereto will be described as other side X2 in the first direction. Also, in the third direction Z, the central axis side of the rotary electric machine 90 will be described as inner side Z1 in the third direction, and the opposite side thereto will be described as outer side Z2 in the third direction.

### (First Busbar 10, Second Busbar 20)

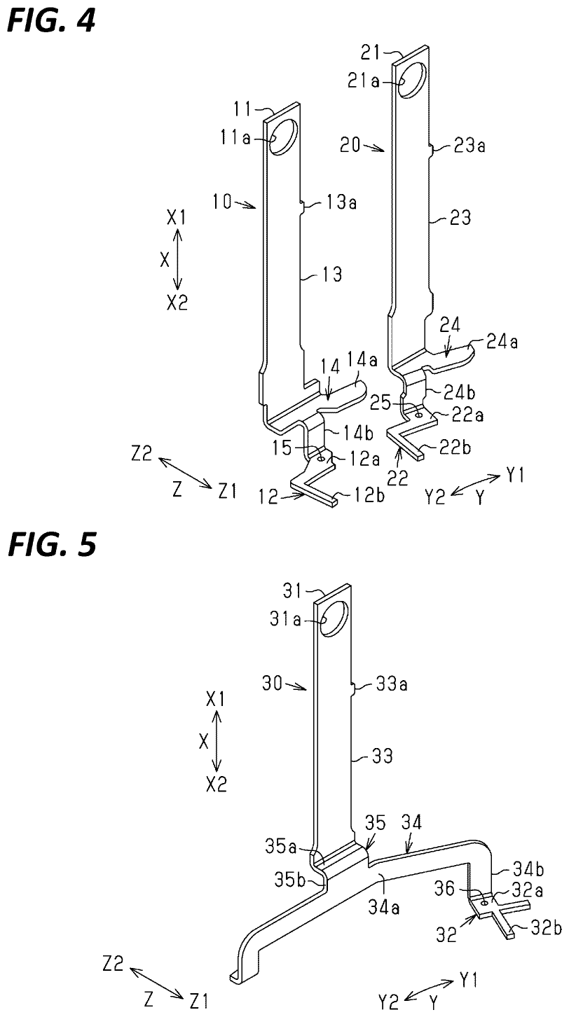

As shown in FIG. 4, the first busbar 10 and the second busbar 20 are each integrally formed of a conductive metal plate material.

The first busbar 10 and the second busbar 20 are aligned at an interval from each other in a second direction Y.

Note that, henceforth, in the second direction Y, the second busbar 20 side will be described as one side Y1 in the second direction with respect to the first busbar 10, and the opposite side thereto will be described as other side Y2 in the second direction.

The first busbar 10 has a first end portion 11 that is electrically connected to the first terminal 81 of the terminal block 80 and a second end portion 12 that is electrically connected to the coil 93 of the stator 91.

Also, the first busbar 10 has an extension portion 13 located between the first end portion 11 and the second end portion 12 and an intermediate portion 14 located between the extension portion 13 and the second end portion 12.

The first end portion 11 and the extension portion 13 are a flat plate shape that extends in the first direction X as a whole and in a direction orthogonal to both the first direction X and the third direction Z.

As shown in FIGS. 1 and 4, the first end portion 11 is provided with a fastening hole 11a (see FIG. 4) that passes therethrough in the third direction Z and through which a bolt (not shown) is inserted and is also provided with a nut 11b (see FIG. 1). The nut 11b is fixed to the end surface of the first end portion 11 on the inner side Z1 in the third direction.

The first end portion 11 and the first terminal 81 (see FIG. 1) of the terminal block 80 are fixed to each other, by inserting a bolt (not shown) through a fastening hole (not shown) formed in the one end 81a and the fastening hole 11a and threading the bolt into the nut 11b.

As shown in FIG. 4, the extension portion 13 is an elongated shape that extends continuously from the first end portion 11 in the first direction X.

The extension portion 13 has a raised portion 13a. The raised portion 13a protrudes from the edge surface of the extension portion 13 on the one side Y1 in the second direction. The raised portion 13a is provided at a position closer to the first end portion 11 than a central portion of the extension portion 13 in the first direction X.

The intermediate portion 14 has an intermediate portion main body 14a that is formed to bend from the extension portion 13 and extend in the second direction Y and a leg portion 14b that is formed to bend from the intermediate portion main body 14a and extend in the first direction X and is coupled to the second end portion 12. The intermediate portion main body 14a corresponds to the elongated main body portion.

The intermediate portion main body 14a is a flat plate shape that extends in both the second direction Y and the third direction Z.

The leg portion 14b is coupled to the end surface of the intermediate portion main body 14a on the inner side Z1 in the third direction. The leg portion 14b extends from the intermediate portion main body 14a on the opposite side to the extension portion 13 in the first direction X, that is, on the other side X2 in the first direction.

The second end portion 12 is formed to bend from the end portion of the leg portion 14b on the other side X2 in the first direction and protrude toward the inner side Z1 in the third direction as a whole.

The second end portion 12 has a flat plate-shaped flat plate portion 12a located on the leg portion 14b side in the third direction Z and a rod-shaped protruding portion 12b located on the distal end side thereof.

The flat plate portion 12a is provided with a through hole 15 that passes therethrough in the first direction X.

The protruding portion 12b is an elongated shape that extends in the third direction Z. The protruding portion 12b protrudes from the end surface of the flat plate portion 12a on the inner side Z1 in the third direction. Note that, in the present embodiment, the protruding portion 12b is a portion that is connected to a power line (not shown) of the phase coil of the coil 93 corresponding to phase U.

In the configuration in which the first busbar 10 includes the elongated extension portion 13, the total length of the first end portion 11 and the extension portion 13 in the first direction X can be made larger than the total length of the second end portion 12 and the intermediate portion 14 in the first direction X. With this configuration, the flexibility of the first busbar 10 is improved, enabling the effect of absorbing vibration with the first busbar 10 (extension portion 13) to be enhanced.

As shown in FIG. 4, the second busbar 20 has a first end portion 21 that is electrically connected to the third terminal 83 of the terminal block 80 and a second end portion 22 that is electrically connected to the coil 93 of the stator 91.

Also, the second busbar 20 has an extension portion 23 located between the first end portion 21 and the second end portion 22 and an intermediate portion 24 located between the extension portion 23 and the second end portion 22.

The first end portion 21 and the extension portion 23 are flat plate shapes that extend in the first direction X as a whole and in a direction orthogonal to both the first direction X and the third direction Z.

As shown in FIGS. 1 and 4, the first end portion 21 is provided with a fastening hole 21a (see FIG. 4) that passes therethrough in the third direction Z and through which a bolt (not shown) is inserted and is also provided with a nut 21b (see FIG. 1). The nut 21b is fixed to the end surface of the first end portion 21 on the inner side Z1 in the third direction.

The first end portion 21 and the third terminal 83 (see FIG. 1) of the terminal block 80 are fixed to each other, by inserting a bolt (not shown) through a fastening hole (not shown) formed in the one end 83a and the fastening hole 21a and threading the bolt into the nut 21b.

As shown in FIG. 4, the extension portion 23 is an elongated shape that extends continuously from the first end portion 21 in the first direction X.

The extension portion 23 has a raised portion 23a. The raised portion 23a protrudes from the edge surface of the extension portion 23 on the one side Y1 in the second direction. The raised portion 23a is provided at a position closer to the first end portion 21 than a central portion of the extension portion 23 in the first direction X.

The intermediate portion 24 has an intermediate portion main body 24a that is formed to bend from the extension portion 23 and extend in the second direction Y and a leg portion 24b that is formed to bend from the intermediate portion main body 24a and extend in the first direction X and is coupled to the second end portion 22. The intermediate portion main body 24a corresponds to the elongated main body portion.

The intermediate portion main body 24a is a flat plate shape that extends in both the second direction Y and the third direction Z.

The leg portion 24b is coupled to the end surface of the intermediate portion main body 24a on the inner side Z1 in the third direction. The leg portion 24b extends from the intermediate portion main body 24a on the opposite side to the extension portion 23 in the first direction X, that is, on the other side X2 in the first direction.

The second end portion 22 is formed to bend from the end portion of the leg portion 24b on the other side X2 in the first direction and protrude toward the inner side Z1 in the third direction as a whole.

The second end portion 22 has a flat plate-shaped flat plate portion 22a located on the leg portion 24b side in the third direction Z and a rod-shaped protruding portion 22b located on the distal end side thereof.

The flat plate portion 22a is provided with a through hole 25 that passes therethrough in the first direction X.

The protruding portion 22b is an elongated shape that extends in the third direction Z. The protruding portion 22b protrudes from the end surface of the flat plate portion 22a on the inner side Z1 in the third direction. Note that, in the present embodiment, the protruding portion 22b is a portion that is connected to a power line (not shown) of the phase coil of the coil 93 corresponding to phase W.

In the configuration in which the second busbar 20 includes the elongated extension portion 23, the total length of the first end portion 21 and the extension portion 23 in the first direction X can be made larger than the total length of the second end portion 22 and the intermediate portion 24 in the first direction X. With this configuration, the flexibility of the second busbar 20 is improved, enabling the effect of absorbing vibration with the second busbar 20 (extension portion 23) to be enhanced.

### (Third Busbar 30)

As shown in FIG. 5, the third busbar 30 is integrally formed of a conductive metal plate material.

The third busbar 30 has a first end portion 31 that is electrically connected to the second terminal 82 of the terminal block 80 and a second end portion 32 that is electrically connected to the coil 93 of the stator 91.

Also, the third busbar 30 has an extension portion 33 located between the first end portion 31 and the second end portion 32, an intermediate portion 34 located between the extension portion 33 and the second end portion 32, and a bent portion 35 located between the extension portion 33 and the intermediate portion 34.

The first end portion 31 and the extension portion 33 are flat plate shapes that extend in the first direction X as a whole and in a direction orthogonal to both the first direction X and the third direction Z.

As shown in FIGS. 1 and 5, the first end portion 31 is provided with a fastening hole 31a (see FIG. 5) that passes therethrough the third direction Z and through which a bolt (not shown) is inserted and is also provided with a nut 31b (see FIG. 1). The nut 31b is fixed to the end surface of the first end portion 31 on the inner side Z1 in the third direction.

The first end portion 31 and the second terminal 82 (see FIG. 1) of the terminal block 80 are fixed to each other, by inserting a bolt (not shown) into a fastening hole (not shown) formed in the one end 82a and the fastening hole 31a and threading the bolt into the nut 31b.

As shown in FIG. 5, the extension portion 33 is an elongated shape that extends continuously from the first end portion 31 in the first direction X.

The extension portion 33 has a raised portion 33a. The raised portion 33a protrudes from the edge surface of the extension portion 33 on the one side Y1 in the second direction. The raised portion 33a is provided at a position closer to the first end portion 31 than a central portion of the extension portion 33 in the first direction X.

The bent portion 35 includes a first portion 35a that is formed to bend from the extension portion 33 and extend in the third direction Z and a second portion 35b that is formed to bend from the first portion 35a and extend in the first direction X and is coupled to the intermediate portion 34.

The first portion 35a is formed to bend from the extension portion 33 and extend on the inner side Z1 in the third direction.

The second portion 35b is formed to bend from the distal end of the first portion 35a and extend on the other side X2 in the first direction.

The intermediate portion 34 has an elongated intermediate portion main body 34a that extends in the second direction Y and a leg portion 34b that is formed to bend from the intermediate portion main body 34a and extend in the first direction X and is coupled to the second end portion 32. The intermediate portion main body 34a corresponds to the elongated main body portion.

The intermediate portion main body 34a is a flat plate shape that extends in both the first direction X and the second direction Y as a whole. The second portion 35b of the bent portion 35 is coupled to a central portion, in the second direction Y, of the end surface of the intermediate portion main body 34a on the one side X1 in the first direction.

The leg portion 34b is formed to bend from the end portion of the intermediate portion main body 34a on the one side Y1 in the second direction and extends on the opposite side to the extension portion 33 in the first direction X, that is, on the other side X2 in the first direction.

The second end portion 32 is formed to bend from the end portion of the leg portion 34b on the other side X2 in the first direction and protrude toward the inner side Z1 in the third direction as a whole.

The second end portion 32 has a flat plate-shaped flat plate portion 32a located on the leg portion 34b side in the third direction Z and a rod-shaped protruding portion 32b located on the distal end side thereof.

The flat plate portion 32a is provided with a through hole 36 that passes therethrough in the first direction X.

The protruding portion 32b is an elongated shape that extends in the third direction Z. The protruding portion 32b protrudes from the end surface of the flat plate portion 32a on the inner side Z1 in the third direction. Note that, in the present embodiment, the protruding portion 32b is a portion that is connected to a power line (not shown) of the phase coil of the coil 93 corresponding to phase V.

In the configuration in which the third busbar 30 includes the elongated extension portion 33, the total length of the first end portion 31 and the extension portion 33 in the first direction X can be made longer than the total length of the second end portion 32 and the intermediate portion 34 in the first direction X or the total length of the second end portion 32, the intermediate portion 34, and the bent portion 35 in the first direction X. With this configuration, the flexibility of the third busbar 30 is improved, enabling the effect of absorbing vibration with the third busbar 30 (extension portion 33) to be enhanced.

### (Fourth Busbar 40)

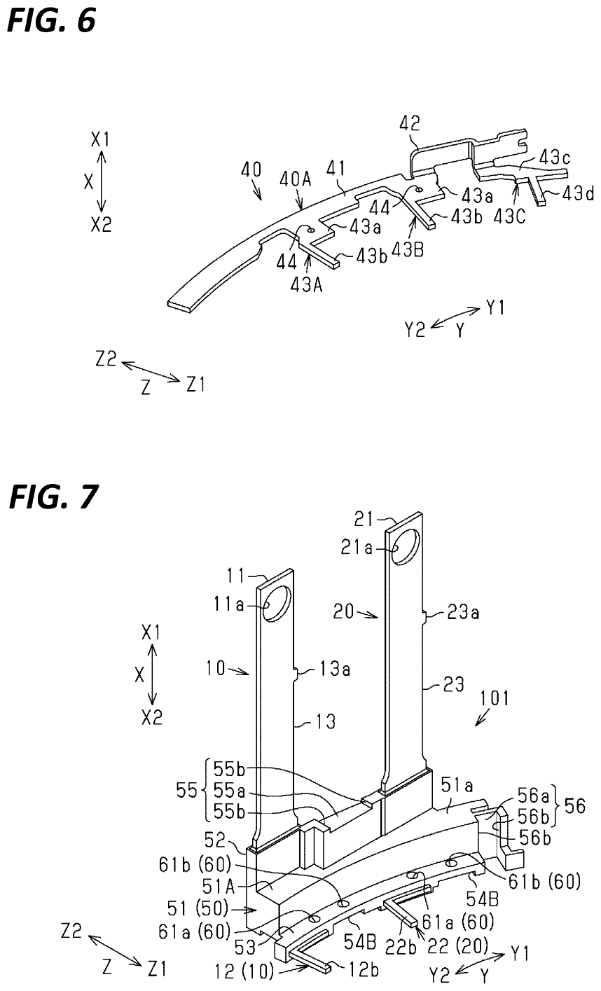

As shown in FIG. 6, the fourth busbar 40 is integrally formed of a conductive metal plate material.

The fourth busbar 40 forms a neutral of the coil 93, and has third end portions 43A, 43B, and 43C that are connected to a neutral wire (not shown) of the coil 93 and an intermediate portion 40A to which the third end portions 43A, 43B, and 43C are coupled.

The intermediate portion 40A extends in the second direction Y as a whole.

The intermediate portion 40A has a first intermediate portion 41 located between the third end portion 43A and the third end portion 43B, and a second intermediate portion 42 located between the third end portion 43B and the third end portion 43C.

The first intermediate portion 41 is a flat plate shape that extends in both the second direction Y and the third direction Z.

The second intermediate portion 42 extends upward on the one side X1 in the first direction from the end portion of the first intermediate portion 41 on the one side Y1 in the second direction and extends toward the one side Y1 in the second direction.

The third end portions 43A, 43B, and 43C are aligned in the stated order from the other side Y2 in the second direction toward the one side Y1 in the second direction. The third end portions 43A, 43B, and 43C are aligned equidistantly from each other in the second direction Y.

The third end portions 43A and 43B protrude from the end surface of the first intermediate portion 41 on the inner side Z1 in the third direction toward the inner side Z1 in the third direction as a whole.

The third end portions 43A and 43B each have a flat plate-shaped flat plate portion 43a located on the first intermediate portion 41 side in the third direction Z and a rod-shaped protruding portion 43b located on the distal end side thereof.

The flat plate portion 43a is provided with a through hole 44 that passes therethrough in the first direction X.

The protruding portion 43b is an elongated shape that extends in the third direction Z. The protruding portion 43b protrudes from the end surface of the flat plate portion 43a on the inner side Z1 in the third direction.

The third end portion 43C is formed to bend from the end surface of the second intermediate portion 42 on the other side X2 in the first direction and protrudes toward the inner side Z1 in the third direction as a whole.

The third end portion 43C has an inclined portion 43c located on the second intermediate portion 42 side in the third direction Z and a rod-shaped protruding portion 43d located on the distal end side thereof.

The inclined portion 43c is inclined so as to proceed toward the one side Y1 in the second direction, as the distance from the second intermediate portion 42 in the third direction Z increases.

The protruding portion 43d is an elongated shape that extends in the third direction Z. The protruding portion 43d protrudes from the end surface of the inclined portion 43c on the inner side Z1 in the third direction.

Note that, in the present embodiment, the protrusions 43b and 43d are portions that are connected to a neutral wire (not shown) of the coil 93.

### (Basic Configuration of Holding Member 50)

As shown in FIGS. 1 to 8, the holding member 50 is formed of a resin material having electrical insulating properties, and covers the busbars 10, 20, 30, and 40.

The holding member 50 has a first holding part 51 that covers the first busbar 10 and the second busbar 20 and is interposed between both busbars 10 and 20 and a second holding part 57 that covers the first holding part 51, the third busbar 30, and the fourth busbar 40.

Also, the holding member 50 has a plurality of communication holes 60 that communicate with the through holes 15, 25, 36, and 44 in the first direction X. The communication holes 60 include first holes 61a and 61b formed in the first holding part 51 and second holes 62 formed in the second holding part 57.

Hereinafter, constituent elements of the holding member 50 will be described in detail.

### (First Holding Part 51)

As shown in FIGS. 4, 7 and 8, the first holding part 51 has a base portion 51A, a first enclosing portion 52 that covers the extension portions 13 and 23, and a second enclosing portion 53 that covers the second end portions 12 and 22.

The base portion 51A extends in the second direction Y and collectively covers the entirety of the intermediate portions 14 and 24 of the first busbar 10 and the second busbar 20.

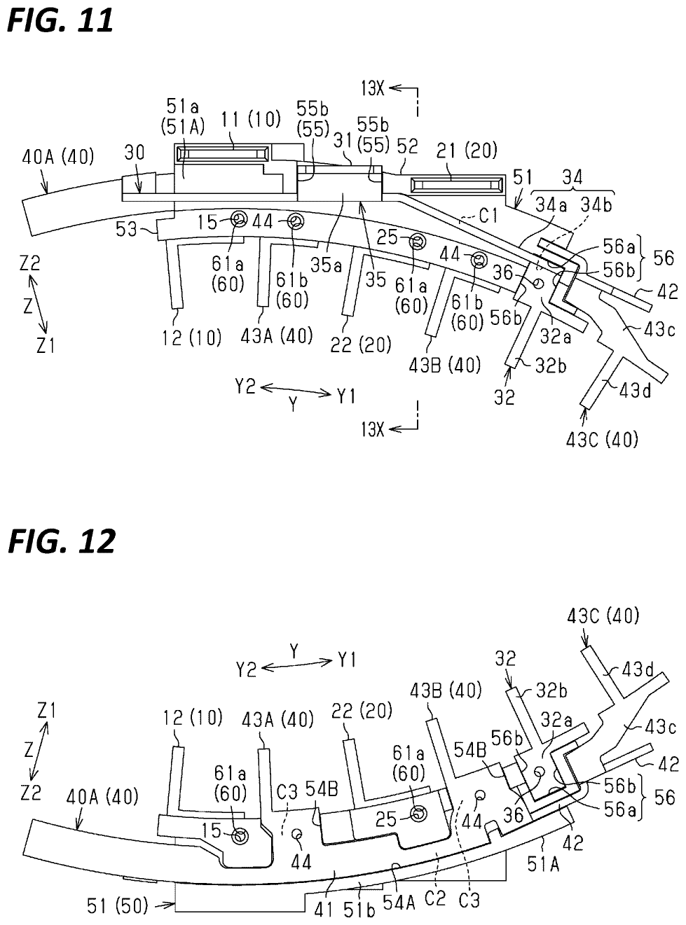

As shown in FIG. 11, the base portion 51A has a first contact surface C1 that the end surface of the intermediate portion 34 of the third busbar 30 on the other side X2 in the first direction comes into contact with. The first contact surface C1 extends along the intermediate portion 34. The first contact surface C1 is provided on an end surface 51a of the base portion 51A on the one side X1 in the first direction (near side in direction orthogonal to surface of FIG. 11).

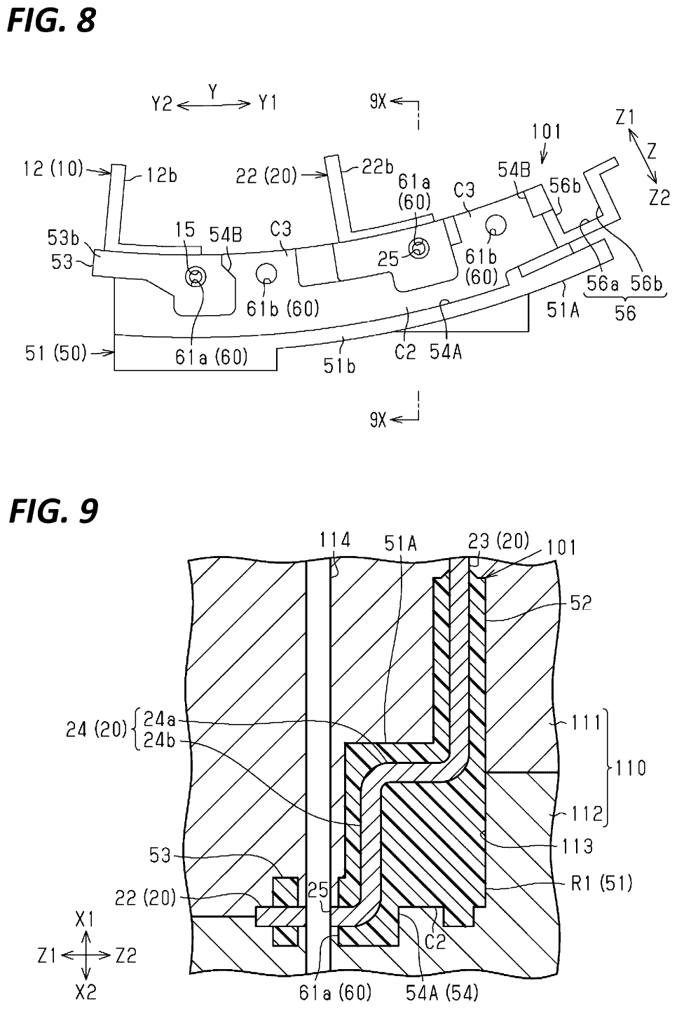

As shown in FIGS. 8 and 12, a fitting recessed portion 54A into which the intermediate portion 40A of the fourth busbar 40 fits is formed in an end surface 51b on the opposite side to the end surface 51a of the base portion 51A in the first direction X. A bottom surface of the fitting recessed portion 54A constitutes a second contact surface C2 that the end surface of the intermediate portion 40A on the one side X1 in the first direction comes into contact with.

As shown in FIGS. 4 and 7, the first enclosing portion 52 protrudes on the one side X1 in the first direction from the end surface 51a of the base portion 51A and partially covers the extension portions 13 and 23.

As shown in FIGS. 7, 10 and 11, the first enclosing portion 52 has a first groove portion 55 into which the bent portion 35 of the third busbar 30 fits on the end surface thereof on the one side X1 in the first direction. The first groove portion 55 is located in a central portion of the first enclosing portion 52 in the second direction Y.

The first groove portion 55 has a bottom surface 55a that the first portion 35a of the bent portion 35 of the third busbar 30 comes into contact with, and a pair of side surfaces 55b that extend upward on the one side X1 in the first direction from both sides of the bottom surface 55a in the second direction Y.

As shown in FIG. 11, the pair of side surfaces 55b sandwich the first portion 35a of the bent portion 35 in the second direction Y. The distance between the pair of side surfaces 55b is slightly larger than the width of the first portion 35a.

As shown in FIGS. 4, 7 and 8, the second enclosing portion 53 protrudes on the inner side Z1 in the third direction from the base portion 51A and covers the flat plate portions 12a and 22a of the second end portions 12 and 22.

As shown in FIGS. 8 and 12, a fitting recessed portion 54B that joins to the fitting recessed portion 54A and into which the third end portions 43A and 43B of the fourth busbar 40 fit is formed in an end surface 53b of the second enclosing portion 53 on the other side X2 in the first direction. A bottom surface of the fitting recessed portion 54B constitutes a third contact surface C3 that the end surfaces of the third end portions 43A and 43B on the one side X1 in the first direction come into contact with.

As shown in FIGS. 4, 7 and 8, the second enclosing portion 53 is provided with two each of the first holes 61a and 61b. The first holes 61a and 61b are provided alternately from the other side Y2 in the second direction toward the one side Y1 in the second direction. The first holes 61a respectively communicate with the through hole 15 of the first busbar 10 and the through hole 25 of the second busbar 20 in the first direction X.

As shown in FIGS. 7 and 8, a second groove portion 56 into which part of the intermediate portion 34 and the second end portion 32 of the third busbar 30 fit is provided in the end surface of the first holding part 51 on the inner side Z1 in the third direction. The second groove portion 56 extends continuously from the base portion 51A and to the second enclosing portion 53 in the first direction X. The second groove portion 56 has a bottom surface 56a that the leg portion 34b of the intermediate portion 34 of the third busbar 30 comes into contact with and a pair of side surfaces 56b that extend upward on the inner side Z1 in the third direction from both sides of the bottom surface 56a in the second direction Y.

As shown in FIGS. 11 and 12, the pair of side surfaces 56b sandwich the leg portion 34b of the intermediate portion 34 and the flat plate portion 32a of the second end portion 32 in the second direction Y. The distance between the pair of side surfaces 56b is slightly larger than the width of the leg portion 34b and the flat plate portion 32a.

### (Configuration of Second Holding Part 57)

As shown in FIGS. 1 and 3, the second holding part 57 has a base portion 58 that extends in the second direction Y and a third enclosing portion 59 that covers part of the third busbar 30.

As shown in FIGS. 1 to 8, the base portion 58 covers the flat plate portion 32a of the second end portion 32 of the third busbar 30. Also, the base portion 58 covers the end surface of the first holding part 51 on the other side X2 in the first direction and covers the intermediate portion 40A and parts of the third end portions 43A, 43B, and 43C of the fourth busbar 40. Specifically, the base portion 58 covers the flat plate portions 43a of the third end portions 43A and 43B and the inclined portion 43c of the third end portion 43C.

As shown in FIG. 3, five second holes 62 are formed in the base portion 58.

As shown in FIGS. 1 and 3 to 8, the second holes 62 respectively communicate in the first direction X with the through hole 15 of the first busbar 10, the through hole 25 of the second busbar 20, the through hole 36 of the third busbar 30, and the two through holes 44 of the fourth busbar 40. The second holes 62 communicating with the through holes 15 and 25 also communicate in the first direction X with the first holes 61a.

As shown in FIGS. 1 and 5, the third enclosing portion 59 protrudes on the one side X1 in the first direction from the base portion 58. The third enclosing portion 59 covers the intermediate portion 34 and part of the second portion 35b of the bent portion 35 of the third busbar 30. Also, the second groove portion 56 of the first holding part 51 is occupied by the third enclosing portion 59 and the base portion 58 (see FIG. 1).

### (Coupling Member 70)

As shown in FIGS. 1, 2 and 14, the coupling member 70 is formed of a resin material having electrical insulating properties, and integrally covers the extension portions 13, 23, and 33 of the busbars 10, 20, and 30.

The coupling member 70 has a first portion 71 that covers the first busbar 10, a second portion 72 that covers the third busbar 30, and a third portion 73 that covers the second busbar 20.

The second portion 72 is located between the first portion 71 and the third portion 73 in the third direction Z.

The first portion 71, the second portion 72, and the third portion 73 are aligned in the second direction Y, and the portions that are adjacent to each other in the second direction Y are coupled together.

The first portion 71, the second portion 72, and the third portion 73 respectively have holes 71a, 72a, and 73a that the extension portions 13, 33, and 23 pass through in the first direction X.

As shown in FIG. 14, a recessed portion 71c is formed in an inner circumferential surface 71b of the hole 71a at a position corresponding to the raised portion 13a protruding toward the inner circumferential surface 71b. Similarly, recessed portions (not shown) are formed in inner circumferential surfaces of the holes 72a and 73a at positions respectively corresponding to the raised portions 33a and 23a that protrude toward the inner circumferential surfaces. Note that the recessed portions of the second portion 72 and the third portion 73 are provided with a similar configuration to the recessed portion 71c of the first portion 71. Thus, henceforth, only the recessed portion 71c of the first portion 71 will be described, and description of the recessed portions of the second portion 72 and the third portion 73 will be omitted.

The raised portion 13a is fitted into the recessed portion 71c. The recessed portion 71c and the raised portion 13a are configured to restrict movement of the first portion 71, that is, the coupling member 70, in the first direction X relative to the extension portion 13, by engaging with each other.

Note that the raised portion 13a and the recessed portion 71c correspond to the restricting part described in the Description of Embodiments of Disclosure section.

### (Method for Manufacturing Terminal Module 100)

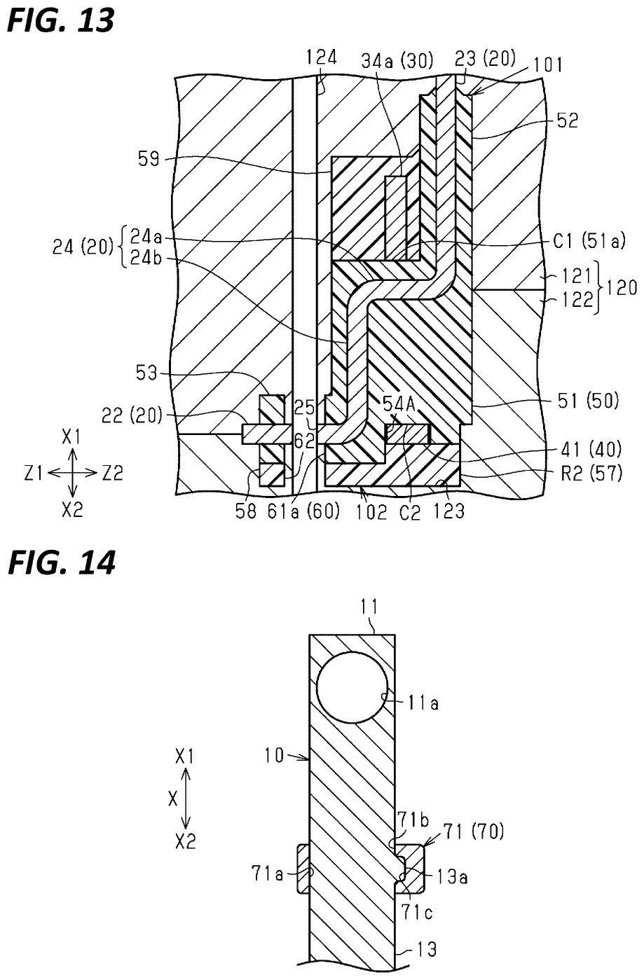

Next, a method for manufacturing the terminal module 100 will be described, with reference to FIGS. 9 to 13. Note that FIG. 9 corresponds to a cross-sectional view taken along line 9X-9X in FIG. 8, and FIG. 13 corresponds to a cross-sectional view taken along line 13X-13X in FIG. 11.

First, as shown in FIG. 9, a positioning pin 114 is inserted into the through hole 25 of the second busbar 20. Also, although not shown, a positioning pin 114 is inserted into the through hole 15 of the first busbar 10. In this state, an upper mold 111 and a lower mold 112 of a first shaping mold 110 are clamped. The first busbar 10 and the second busbar 20 inserted into the first shaping mold 110 are thereby positioned with respect to a cavity 113.

Next, the cavity 113 of the first shaping mold 110 is filled with molten resin R1. A primary mold body 101 constituted by the first busbar 10, the second busbar 20, and the first holding part 51 is thereby formed. At this time, the first holes 61a that respectively communicate with the through holes 15 and 25 are formed in the first holding part 51. Also, the first holes 61b are formed in the first holding part 51 by pins not shown.

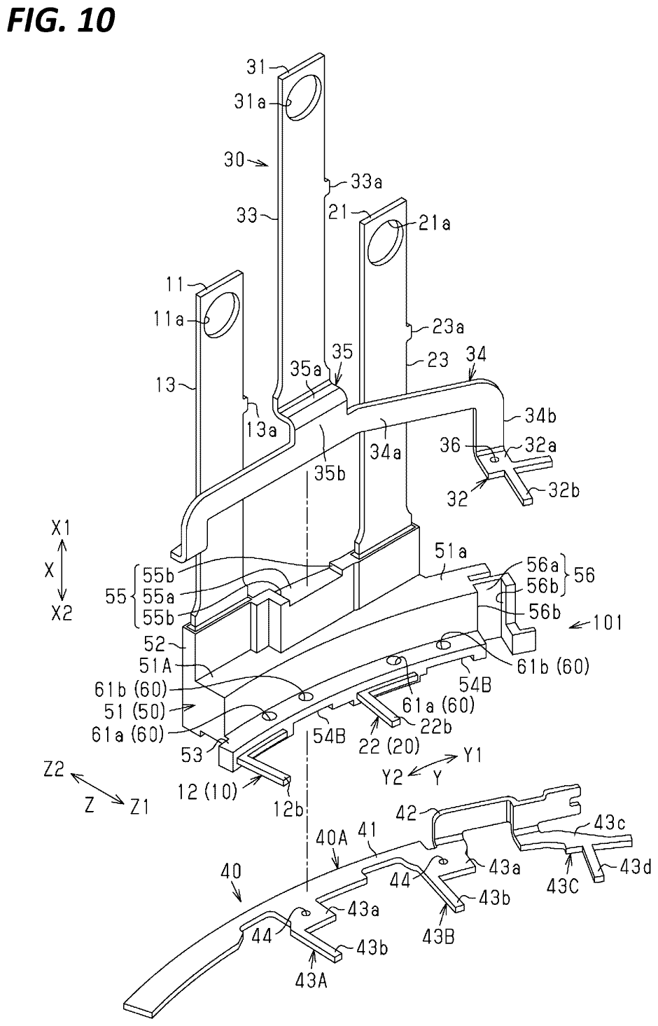

Next, as shown in FIG. 10, the third busbar 30 and the fourth busbar 40 are attached to the primary mold body 101.

As shown in FIGS. 10 and 11, the first portion 35a of the bent portion 35 is fitted into the first groove portion 55, and the leg portion 34b of the intermediate portion 34 and the flat plate portion 32a of the second end portion 32 are fitted into the second groove portion 56. The third busbar 30 is thereby positioned with respect to the primary mold body 101.

At this time, the end surface of the intermediate portion main body 34a of the third busbar 30 on the other side X2 in the first direction is in contact with the end surface 51a (first contact surface C1) of the base portion 51A (see FIG. 13). Also, the first portion 35a of the bent portion 35 is in contact with the bottom surface 55a of the first groove portion 55 (see FIG. 1). Also, the end surface of the leg portion 34b on the outer side Z2 in the third direction is in contact with the bottom surface 56a.

Here, the length of the bent portion 35 in the third direction Z may be adjusted. Specifically, the length of the first portion 35a of the bent portion 35 in the third direction Z is changed. The height of the extension portion 33 in the first direction X, that is, the position of the first end portion 31 in the first direction X, and the position of the extension portion 33 in the third direction Z are thereby adjusted.

Note that the position of the first end portion 31 in the first direction X is adjusted in the same manner as the positions of the first end portions 11 and 21 in the first direction X (see FIG. 1). Also, the position of the extension portion 33 in the third direction Z is adjusted such that the extension portion 33 is located between the extension portion 13 of the first busbar 10 and the extension portion 23 of the second busbar 20 in the third direction Z (see FIG. 11). The extension portions 13, 23, and 33, and, hence, the first end portions 11, 21, and 31, will thereby be aligned in the second direction Y.

As shown in FIGS. 10 and 12, the fourth busbar 40 is attached to the fitting recessed portions 54A and 54B of the first holding part 51. The fourth busbar 40 is thereby positioned in the normal attachment position with respect to the primary mold body 101. At this time, the end surface of the fourth busbar 40 on the one side X1 in the first direction will be in contact with the second contact surface C2 of the base portion 51A and the third contact surface C3 of the second enclosing portion 53.

Note that, as shown in FIG. 13, in a state where the third busbar 30 and the fourth busbar 40 are attached to the primary mold body 101, the third busbar 30, the second busbar 20, and the fourth busbar 40 are disposed at an interval from each other in the first direction X. Also, similarly, the third busbar 30, the first busbar 10 (not shown), and the fourth busbar 40 are disposed at an interval from each other in the first direction X.

Next, a positioning pin 124 is inserted into the through hole 25 of the second busbar 20. Also, although not shown, positioning pins 124 are inserted into the through holes 36 and 44 of the third busbar 30 and the fourth busbar 40. In this state, as shown in FIG. 13, an upper mold 121 and a lower mold 122 of a second shaping mold 120 are clamped. The primary mold body 101, the third busbar 30, and the fourth busbar 40 inserted into the second shaping mold 120 are thereby positioned with respect to a cavity 123.

Next, the cavity 123 of the second shaping mold 120 is filled with molten resin R2. A secondary mold body 102 constituted by the primary mold body 101, the third busbar 30, the fourth busbar 40, and the second holding part 57 is thereby formed. At this time, as shown in FIG. 13, the second holes 62 that communicate with the first holes 61a communicating with the through hole 15 and the through hole 25, the through hole 36, and the first holes 61b communicating with the two through holes 44 are formed in the second holding part 57.

Note that, at this time, the second end portion 12, the third end portion 43A, the second end portion 22, the third end portion 43B, the second end portion 32, and the third end portion 43C are disposed in the stated order from the other side Y2 in the second direction toward the one side Y1 in the second direction and are aligned equidistantly from each other in the second direction Y (see FIGS. 1 to 3).

Next, the operation and effect of the present embodiment will be described.

(1) The first busbar 10 is located between the first end portion 11 and the second end portion 12, and has the elongated extension portion 13 that extends in the first direction X. The second busbar 20 is located between the first end portion 21 and the second end portion 22, and has the elongated extension portion 23 that extends in the first direction X. The third busbar 30 is located between the first end portion 31 and the second end portion 32, and has the elongated extension portion 33 that extends in the first direction X. The extension portions 13, 23, and 33 are configured to be capable of reducing vibration transmitted toward the terminal block 80 from the stator 91.

According to this configuration, the holding member 50 integrally holds the first busbar 10, the second busbar 20, and the third busbar 30, and is interposed between the busbars 10, 20, and 30. Accordingly, the busbars 10, 20, and 30 are electrically insulated from each other by the holding member 50.

Also, according to the above configuration, the first busbar 10, the second busbar 20, and the third busbar 30 have elongated extension portions 13, 23, and 33 that extend in the first direction X, and thus flexibility is enhanced. As a result, vibrations transmitted toward the terminal block 80 from the stator 91 becomes more likely to be absorbed by the extension portions 13, 23, and 33. Accordingly, vibration transmitted from the rotary electric machine 90 can be reduced with a simple configuration.

(2) The coupling member 70 that is formed of an electrically insulating resin and integrally covers the extension portions 13, 23, and 33 of the first busbar 10, the second busbar 20, and the third busbar 30 is provided.

With the busbars 10, 20, and 30, the extension portions 13, 23, and 33 are more likely to relatively shift in position, the longer the length of the extension portions 13, 23, and 33 in the first direction X. In this regard, according to the above configuration, the extension portions 13, 23, and 33 of the busbars 10, 20, and 30 are integrally coupled together by the coupling member 70. Position shift of the extension portions 13, 23, and 33 of the busbars 10, 20, and 30 from the normal position can thereby be suppressed. Accordingly, work efficiency when connecting the first end portions 11, 21, and 31 of the busbars 10, 20, and 30 to the terminal block 80 can be improved.

(3) The coupling member 70 has the plurality of holes 71a, 72a, and 73a that pass through the extension portions 13, 23, and 33 in the first direction X. The extension portion 13 of the first busbar 10 has the raised portion 13a serving as a restricting part. The coupling member 70 has the recessed portion 71c serving as a restricting part.

According to this configuration, movement of the coupling member 70 in the first direction X relative to the extension portions 13, 23, and 33 of the busbars 10, 20, and 30 is restricted by the restricting part. Accordingly, positioning of the coupling member 70 with respect to the busbars 10, 20, and 30 can be readily performed.

(4) The restricting part has the raised portion 13a protruding toward the inner circumferential surface 71b of the hole 71a from the extension portion 13 of the first busbar 10 and the recessed portion 71c formed on the inner circumferential surface 71b.

According to this configuration, any movement by the coupling member 70 in the first direction X relative to the extension portions 13, 23, and 33 of the busbars 10, 20, and 30 is restricted by the engaging relationship between the raised portion 13a protruding from the extension portion 13 and the recessed portion 71c formed on the inner circumferential surface 71b of the hole 71a in the coupling member 70. Accordingly, the restricting part can be realized with a simple configuration.

(5) The raised portion 13a (23a, 33a) is provided at a position closer to the first end portion 11 (21, 31) than the central portion of the extension portion 13 (23, 33) in the first direction X.

With the extension portions 13, 23, and 33, position shift from the normal position is more likely to occur closer to the first end portions 11, 21, and 31. In this regard, according to the above configuration, the raised portion 13a is provided at a position closer to the first end portion 11 than the central portion of the extension portion 13 in the first direction X. Thus, the coupling member 70 will be located closer to the first end portion 11 than the central portion. Position shift of the extension portions 13, 23, and 33 of the busbars 10, 20, and 30 from the normal position can thereby be effectively suppressed. Accordingly, work efficiency when connecting the first end portions 11, 21, and 31 of the busbars to the terminal block 80 can be further improved.

(6) The intermediate portions 14, 24, and 34 of the first busbar 10, the second busbar 20, and the third busbar 30 have the elongated intermediate portions 14a, 24a, and 34a that extend in the second direction Y and the leg portions 14b, 24b, and 34b that are formed to bend from the intermediate portion main bodies 14a, 24a, and 34a and extend on the opposite side to the extension portions 13, 23, and 33 in the first direction X and are coupled to the second end portions 12, 22, and 32.

In a conventional terminal module, leg portions that join to the second end portions 12, 22, and 32 extend in the third direction Z, and thus reducing the size of the rotary electric machine 90 in the third direction Z is difficult.

In this regard, according to the above configuration, the leg portions 14b, 24b, and 34b of the intermediate portions 14, 24, and 34 are bent from the intermediate portion main bodies 14a, 24a, and 34a and extend on the opposite side to the first end portions 11, 21, and 31 in the first direction X. Thus, the lengths of the intermediate portions 14, 24, and 34 in the third direction Z can be reduced, compared to the conventional busbars in which the leg portions 14b, 24b, and 34b extend from the intermediate portion main bodies 14a, 24a, and 34a in the third direction Z. Accordingly, the physical size of the terminal module 100 can be reduced in the third direction Z.

(7) The holding member 50 has the first holding part 51 that covers the first busbar 10 and the second busbar 20 and is interposed between the first busbar 10 and the second busbar 20, and the second holding part 57 that covers the first holding part 51 and the third busbar 30.

When the cross-sectional area of the gap between the busbars 10, 20, and 30 is small in the case where the holding member 50 integrally holds the first busbar 10, the second busbar 20, and the third busbar 30, molten resin will not flow readily through this gap within the cavity formed by the busbars 10, 20, and 30 and the shaping mold that forms the holding member 50. In the case where the cross-sectional area of the flow path on the opposite side to the above gap with the busbar 10, 20, and 30 interposed therebetween within the cavity is large compared to the cross-sectional area of the gap, a difference thereby occurs between the flow pressure of the molten resin that flows through the gap and the flow pressure of the molten resin that flows through the flow path. Thus, there is a problem in that the busbars 10, 20, and 30 are likely to shift in position from the normal position due to such a pressure difference.

In this regard, according to the above configuration, first, the primary mold body 101 constituted by the first busbar 10, the second busbar 20 and the first holding part 51 is formed, by filling the cavity 113 of the first shaping mold 110 with the molten resin R1, in a state where the first busbar 10 and the second busbar 20 are inserted into the first shaping mold 110. Next, the secondary mold body 102 constituted by the primary mold body 101, the third busbar 30, and the second holding part 57 is formed, by filling the cavity 123 of the second shaping mold 120 with the molten resin R2, in a state where the primary mold body 101 and the third busbar 30 are inserted into the second shaping mold 120.

Thus, the interval between the first busbar 10 and the second busbar 20 can be increased, compared to the case where the cavity of the shaping mold is filled with molten resin in a state where the first busbar 10, the second busbar 20, and the third busbar 30 are inserted into the shaping mold. The occurrence of a difference in flow pressure of the molten resin R1 is thereby suppressed. Accordingly, position shift of the first busbar 10 and the second busbar 20 can be suppressed.

(8) The third busbar 30 has the bent portion 35 between the extension portion 33 and the intermediate portion 34 of the third busbar 30. The bent portion 35 has the first portion 35a that is formed to bend from the extension portion 33 and extend on the inner side Z1 in the third direction.

According to this configuration, the height of the extension portion 33 in the first direction X, that is, the position of the first end portion 31 in the first direction X, and the position of the extension portion 33 in the third direction Z are adjusted simply by changing the length of the bent portion 35 in the third direction Z. The dimensions of the extension portion 33 of the third busbar 30 can thereby be adjusted after forming the primary mold body 101. Accordingly, the third busbar 30 is less likely to shift in position, compared to the case where the cavity of the shaping mold is filled with molten resin in a state where the first busbar 10, the second busbar 20, and the third busbar 30 are inserted into the shaping mold. Accordingly, position shift of the third busbar 30 can be suppressed.

(9) The first holding part 51 has the first groove portion 55 into which the first portion 35a of the bent portion 35 of the third busbar 30 fits. The first groove portion 55 includes the bottom surface 55a that the first portion 35a comes into contact with and the pair of side surfaces 55b that extend upward from both sides of the bottom surface 55a in the second direction Y. The pair of side surfaces 55b sandwich the first portion 35a in the second direction Y. Also, the first holding part 51 has the second groove portion 56 into which the leg portion 34b and the flat plate portion 32a of the third busbar 30 fit. The second groove portion 56 includes the bottom surface 56a that the leg portion 34b comes into contact with and the pair of side surfaces 56b that extend upward from both sides of the bottom surface 56a in the second direction Y. The pair of side surfaces 56b sandwich the leg portion 34b and the flat plate portion 32a in the second direction Y.

According to this configuration, when forming the secondary mold body 102, movement of the third busbar 30 in the second direction Y relative to the primary mold body 101 due to the flow pressure of the molten resin R2 is restricted by interference between the pair of side surfaces 55b of the first groove portion 55 and the first portion 35a of the third busbar 30 fitted into the first groove portion 55. Similarly, movement of the third busbar 30 in the second direction Y relative to the primary mold body 101 is restricted by interference between the pair of side surfaces 56b of the second groove portion 56 and the leg portion 34b and the flat plate portion 32a of the third busbar 30 fitted into the second groove portion 56. Accordingly, position shift of the third busbar 30 can be further suppressed.

(10) The plurality of busbars have the fourth busbar 40 that is electrically connected to a neutral wire of the coil 93. The first holding part 51 is provided with the base portion 51A having the first contact surface C1 that one end surface of the third busbar 30 in the first direction X comes into contact with and the second contact surface C2 and the third contact surface C3 that are located on the opposite side to the first contact surface C1 in the first direction X and that the fourth busbar 40 comes into contact with. The second holding part 57 covers the fourth busbar 40.

According to this configuration, the secondary mold body 102 constituted by the primary mold body 101, the third busbar 30, the fourth busbar 40 and the second holding part 57 is formed, by filling the cavity 123 of the second shaping mold 120 with the molten resin R2, in a state where the primary mold body 101, the third busbar 30, and the fourth busbar 40 are inserted into the second shaping mold 120. At this time, the fourth busbar 40 is in contact with the first holding part 51, and thus there is no gap between the fourth busbar 40 and the first holding part 51. Position shift of the fourth busbar 40 can thus be suppressed, compared to the case where the cavity is filled with the molten resin R2 in a state where there is a gap between the fourth busbar 40 and the first holding part 51.

### <Modifications>

The present embodiment can be implemented in a modified manner as follows. The present embodiment and the following modifications can be implemented in combination with each other to the extent that no technical inconsistencies arise.

The terminal module 100 may have a temperature sensor that detects the temperature of the coil 93 by detecting the temperature of the busbars electrically connected to the coil 93. In this case, the disposition of the temperature sensor can be selected as appropriate according to the requirements for installing the terminal module 100 on the stator 91. For example, the temperature sensor may be provided at the end portion of the terminal module 100 on the one side Y1 in the second direction or may be provided at the end portion on the other side Y2 in the second direction.

The shapes of the busbars 10, 20, 30, and 40 are not limited to those illustrated in the present embodiment and may be modified as appropriate according to the requirements for installation on the stator 91, within a range that achieves the operation and effect of the present disclosure. For example, the second intermediate portion 42 of the fourth busbar 40 need not extend upward from the end portion of the first intermediate portion 41 on the one side Y1 in the second direction, and may be a flat plate shape that extends in both the second direction Y and the third direction Z.

The number of fourth busbars 40 is not limited to one as illustrated in the present embodiment, and may, for example, be two or more. Also, the fourth busbar 40 may be omitted. In this case, the fitting recessed portions 54A and 54B can be omitted from the first holding part 51.

The first holding part 51 may, for example, have holes formed by a jig or a positioning pin, in addition to the first holes 61a and 61b. Also, similarly, the second holding part 57 may, for example, have holes formed by a jig or a positioning pin, in addition to the second holes 62.

The second holding part 57 is not limited to having the second holes 62 that communicate with the first holes 61a and 61b in the first direction X as illustrated in the present embodiment. That is, the second holes 62 that communicate with the first holes 61a and 61b in the first direction X may be omitted from the second holding part 57.

The number and disposition of the through holes 15, 25, 36, and 44 are not limited to those illustrated in the present embodiment and may be changed as appropriate according to the shape of the busbars 10, 20, 30, and 40.

The communication holes 60 are not limited to having the second holes 62. That is, the second holes 62 may be omitted from the second holding part 57. In this case, the through hole 36 can be omitted from the third busbar 30. Also, in this case, when forming the secondary mold body 102, for example, the third busbar 30 need only be sandwiched by a jig from both sides in the first direction X.

The first holes 61a and 61b may be omitted. In this case, the through holes 15 and 25 can be omitted from the first busbar 10 and the second busbar 20. Also, in this case, when forming the primary mold body 101, the first busbar 10 and the second busbar 20 need only be sandwiched by a jig from both sides in the first direction X, for example.

The first groove portion 55 may be omitted from the first holding part 51.

The second groove portion 56 may be omitted from the first holding part 51.

The bent portion 35 may be omitted from the third busbar 30. Even in this case, in the third busbar 30, the extension portion 33 need only be located between the extension portion 13 of the first busbar 10 and the extension portion 23 of the second busbar 20 in the second direction Y.

The holding member 50 is not limited to having the first holding part 51 and the second holding part 57. That is, in the terminal module 100, the busbars may be collectively held by the holding member 50.

In the busbars 10, 20, and 30, the leg portions 14b, 24b, and 34b of the intermediate portions 14, 24, and 34 need not be formed to bend from the intermediate portion main bodies 14a, 24a, and 34a and extend on the opposite side to the extension portions 13, 23, and 33 in the first direction X. For example, the leg portions 14b, 24b, and 34b may be formed to bend from the intermediate portion main bodies 14a, 24a, and 34a and extend on the inner side Z1 in the third direction.

The raised portions 13a, 23a, and 33a are not limited to those provided at positions closer to the first end portions 11, 21, and 31 than the central portion of the extension portions 13, 23, and 33 in the first direction X. For example, the raised portions 13a, 23a, and 33a may be provided in the central portion, or may be provided at position closer to the intermediate portions 14, 24, and 34 than the central portion in the first direction X.

The number and disposition of the raised portions 13a, 23a, and 33a may be changed as follows. For example, any one of the raised portions 13a, 23a, and 33a may be omitted, or any two of the raised portions 13a, 23a, and 33a may be omitted. Also, in the present embodiment, the raised portions 13a, 23a, and 33a are illustrated as protruding from the end surfaces of the extension portions 13, 23, and 33 on the one side Y1 in the second direction, but may be modified to protrude from the end surfaces on the other side Y2 in the second direction, or may be modified to protrude one each from the end surfaces on both sides in the second direction Y.

The raised portions 13a, 23a, and 33a may be omitted. In this case, the recessed portions can be omitted from the holes 71a, 72a, and 73a of the coupling member 70.

The coupling member 70 may be omitted.

The disposition of the plurality of busbars is not limited to that illustrated in the present embodiment and can be changed as appropriate according to the requirements for installation on the stator 91. Even in this case, the plurality of busbars need only be disposed at an interval from each other in the first direction X, and need only be disposed in alignment with each other in the second direction Y.

The present disclosure encompasses the following embodiments. Note that, reference numerals indicating constituent elements of the above embodiment are given merely for the purpose of aiding understanding and are not limiting.

### Supplementary Note 1

A terminal module (100) for rotary electric machine that electrically connects a stator (91) constituting a rotary electric machine to a terminal block (80), including: a plurality of busbars (10, 20, 30, 40) each integrally formed of a metal plate material; and a holding member (50) formed of an electrically insulating resin, covering the plurality of busbars, and interposed between the plurality of busbars, wherein, when an axial direction and a circumferential direction of the rotary electric machine are respectively defined as a first direction (X) and a second direction (Y), the plurality of busbars (10, 20, 30, 40) include a first busbar (10), a second busbar (20), and a third busbar (30) disposed in alignment with each other in the second direction (Y), the first, second, and third busbars each have: a first end portion (11, 21, 31) to be electrically connected to the terminal block (80); a second end portion (12, 22, 32) to be electrically connected to a coil (93) of the stator (91); an elongated extension portion (13, 23, 33) located between the first end portion and the second end portion and extending in the first direction (X); and an intermediate portion (14, 24, 34) located between the extension portion and the second end portion and covered by the holding member (50), and a total length of the first end portion and the extension portion in the first direction (X) is greater than a total length of the second end portion and the intermediate portion in the first direction (X).

### LIST OF REFERENCE NUMERALS

C1 First abutting surface
C2 Second abutting surface
C3 Third abutting surface
R1, R2 Molten resin
X First direction
X1 One side
X2 Other side
Y Second direction
Y1 One side
Y2 Other side
Z Third direction
Z1 Inner side
Z2 Outer side
First busbar
11 First end portion
11a Fastening hole
11b Nut
12 Second end portion
12a Flat plate portion
12b Protruding portion
13 Extension portion
13a Raised portion
14 Intermediate portion
14a Intermediate portion main body
14b Leg portion
15 Through hole
20 Second busbar
21 First end portion
21a Fastening hole
21b Nut
22 Second end portion
22a Flat plate portion
22b Protruding portion
23 Extension portion
23a Raised portion
24 Intermediate portion
24a Intermediate portion main body
24b Leg portion
25 Through hole
30 Third busbar
31 First end portion
31a Fastening hole
31b Nut
32 Second end portion
32a Flat plate portion
32b Protruding portion
33 Extension portion
33a Raised portion
34 Intermediate portion
34a Intermediate portion main body
34b Leg portion
35 Bent portion
35a First portion
35b Second portion
36 Through hole
40 Fourth busbar
40A Intermediate portion
41 First intermediate portion
42 Second intermediate portion
43A, 43B, 43C Third end portion
43a Flat plate portion
43b Protruding portion
43c Inclined portion
43d Protruding portion
44 Through hole
50 Holding member
51 First holding part
51A Base portion
51a End surface
51b End surface
52 First enclosing portion
53 Second enclosing portion
53b End surface
54A, 54B Fitting recessed portion
55 First groove portion
55a Bottom surface
55b Side surface
56 Second groove portion
56a Bottom surface
56b Side surface
57 Second holding part
58 Base portion
59 Third enclosing portion
60 Communication hole
61a, 61b First hole
62 Second hole
70 Coupling member
71 First portion
71a Hole
71b Inner circumferential surface
71c Recessed portion
72 Second portion
72a Hole
73 Third portion
73a Hole
80 Terminal block
81 First terminal
81a One end
82 Second terminal
82a One end
83 Third terminal
83a One end
84 Housing
90 Rotary electric machine
91 Stator
92 Stator core
93 Coil
100 Terminal module
101 Primary mold body
102 Secondary mold body
110 First shaping mold
111 Upper mold
112 Lower mold
113 Cavity
114 Pin
120 Second mold
121 Upper mold
122 Lower mold
123 Cavity
124 Pin

1. A terminal module for rotary electric machine that electrically connects a stator constituting a rotary electric machine to a terminal block, comprising:
a plurality of busbars each integrally formed of a metal plate material; and
a holding member formed of an electrically insulating resin, covering the plurality of busbars, and interposed between the plurality of busbars,
wherein, when an axial direction and a circumferential direction of the rotary electric machine are respectively defined as a first direction and a second direction,
the plurality of busbars include a first busbar, a second busbar, and a third busbar disposed in alignment with each other in the second direction and each having:
a first end portion to be electrically connected to the terminal block;
a second end portion to be electrically connected to a coil of the stator;
an elongated extension portion located between the first end portion and the second end portion and extending in the first direction; and
an intermediate portion located between the extension portion and the second end portion and covered by the holding member, and
the extension portion is configured to be capable of reducing vibration transmitted toward the terminal block from the stator.

2. The terminal module for rotary electric machine according to claim 1, further comprising:
a coupling member formed of an electrically insulating resin and integrally covering the extension portion of each of the first busbar, the second busbar, and the third busbar.

3. The terminal module for rotary electric machine according to claim 2,
wherein the coupling member has a plurality of holes that the extension portions respectively pass through in the first direction, and
the coupling member and the extension portion of at least one of the first busbar, the second busbar, and the third busbar include a restricting part that restricts movement of the coupling member in the first direction relative to the extension portion by an engaging relationship.

4. The terminal module for rotary electric machine according to claim 3,
wherein the restricting part includes:
a raised portion protruding toward an inner circumferential surface of the hole from the extension portion of at least one of the first busbar, the second busbar, and the third busbar, and
a recessed portion formed in the inner circumferential surface.

5. The terminal module for rotary electric machine according to claim 4,
wherein the raised portion is provided at a position closer to the first end portion than a central portion of the extension portion in the first direction.

6. The terminal module for rotary electric machine according to claim 1,
wherein the intermediate portion of each of the first busbar, the second busbar, and the third busbar has:
an elongated main body portion extending in the second direction; and
a leg portion formed to bend from the main body portion and extend in the first direction on an opposite side to the extension portion and coupled to the second end portion.

7. The terminal module for rotary electric machine according to claim 6,
wherein the holding member has:
a first holding part covering the first busbar and the second busbar and interposed between the first busbar and the second busbar; and
a second holding part covering the first holding part and the third busbar.

8. The terminal module for rotary electric machine according to claim 7,
wherein, when a radial direction of the rotary electric machine is defined as a third direction,
the third busbar has a bent portion between the extension portion and the intermediate portion of the third busbar, and
the bent portion has a portion formed to bend from the extension portion and extend on an inner side in the third direction.

9. The terminal module for rotary electric machine according to claim 7,
wherein the first holding part has a groove portion into which a portion of the third busbar fits,
the groove portion includes:
a bottom surface that the portion comes into contact with; and
a pair of side surfaces that extend upward from both sides of the bottom surface in the second direction, and
the pair of side surfaces sandwich the portion in the second direction.

10. The terminal module for rotary electric machine according to claim 7,
wherein the plurality of busbars includes a fourth busbar to be electrically connected to a neutral wire of the coil,
the first holding part includes a base portion having:
a first contact surface that one end surface of the third busbar in the first direction comes into contact with; and
a second contact surface located on an opposite side to the first contact surface in the first direction and that the fourth busbar comes into contact with, and
the second holding part covers the fourth busbar.
